(19) United States
(12) Patent Application Publication
(10) Pub. No.: US 2007/0050473 A1
(43) Pub. Date: Mar. 1, 2007

(54) Method and apparatus for controlling power supplied to remote-control-signal reception unit according to opened/closed state of laptop computer

(75) Inventor: Byung-jae Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/509,594

(22) Filed: Aug. 25, 2006

(30) Foreign Application Priority Data
Aug. 26, 2005 (KR) 2005-78853

(51) Int. Cl. G06F 15/16

(52) U.S. Cl. 709/217

(57) ABSTRACT

A method and apparatus for controlling power supplied to a remote-control-signal reception unit of a laptop computer according to an opened or closed state of the laptop computer. The apparatus for controlling power supplied to a remote-control-signal reception unit of a laptop computer according to an opened or closed state of the laptop computer includes an open/close sensing unit that detects the opened or closed state of the laptop computer; a signal reception unit that receives a signal of a remote control unit; a power supply unit that supplies power to the signal reception unit; and a power shut-off unit that shuts off the power supplied to the signal reception unit when the open/close sensing unit detects the closed state of the laptop computer.

### CROSS-REFERENCE TO RELATED APPLICATIONS

This application claims the benefit of Korean Application No. 2005-78853, filed Aug. 26, 2005 in the Korean Intellectual Property Office, the disclosure of which is incorporated herein in its entirety by reference.

### BACKGROUND OF THE INVENTION

1. Field of the Invention

Aspects of the present invention relate to a method and apparatus for controlling power supply in a laptop computer and, more particularly, to a method and apparatus for controlling power supplied to a remote-control-signal reception unit of a laptop computer according to opened/closed state of the laptop computer.

2. Description of the Related Art

Computer technology is rapidly advancing while functions of existing electronic appliances are converging. For example, a remote-control reception unit is provided in a computer to enable control of the computer by a remote control device. Meanwhile, in laptop computers, technologies for supporting multimedia and network functions are rapidly developing in addition to technologies providing various mobile functions. Such developments have been emphasized to provide more convenience and enhancement of mobile functions capable of integrating or interfacing with various multimedia functions of laptop computers.

As such, a remote control device not only allows a user to control a laptop computer from a distance, but it also allows a user to easily use the laptop computer like a home appliance when the user reproduces multimedia content or turns the laptop computer on and off.

FIG. 1 illustrates the structure of a laptop computer controlled by a conventional remote control device.

A remote-control transmission unit 10 transmits an infrared signal to a remote-control reception unit 51 of a laptop computer 50. The remote-control reception unit 51 outputs the received infrared signal to a remote-control-code-conversion microcomputer 52. The microcomputer 52 then converts the infrared signal into a code that activates or deactivates certain functions in the laptop computer 50. The converted code is transmitted to a system microcontroller 53 to activate or deactivate certain functions. For example, the code stops playback of multimedia content, increases or decreases volume, or turns the laptop computer 50 on or off.

Accordingly, a certain level of power supplied to the remote-control reception unit 51 should be maintained in order to turn on the laptop computer 50 by using the remote control device when the laptop computer 50 is turned off. Also, a certain level of power should be continuously provided to the remote-control-code-conversion microcomputer 52 and to the system microcontroller 53 in order to provide such functions. That is, auxiliary power is continuously supplied to control the laptop computer 50 by the remote control device according to the request of a user, which consumes power in the laptop computer 50. A conventional laptop computer typically requires 3.3V voltage and at least 3 mA current during the standby state. As a result, it is necessary to charge the battery frequently, which limits the duration of time that the laptop computer can be used in the mobile mode.

Accordingly, a technology that can allow the functions of a remote control device to be implemented with minimum power consumption in a laptop computer is desired.

### SUMMARY OF THE INVENTION

In view of the foregoing, aspects of the present invention reduce the amount of standby current that is generated when a laptop computer receives a remote control signal.

Further, aspects of the present invention improve the mobility of a laptop computer by reducing power consumption in the laptop computer.

Aspects of the present invention will not be limited to the technical objects described above. Other aspects not described herein will be more definitely understood by those in the art from the following detailed description.

Aspects of the present invention, includes a laptop computer including an open/close sensing unit detecting an opened or closed state of the laptop computer; a signal reception unit receiving a remote control signal transmitted from a remote control device; a power supply unit providing power to the signal reception unit; and a power shut-off unit shutting off the power supplied to the signal reception unit by the power supply unit when the open/close sensing unit detects the closed state of the laptop computer.

According to an aspect of the present invention, there is provided a method of controlling power supplied to a remote-control-signal reception unit of a laptop computer according to an opened or closed state of the laptop computer. The method includes detecting the opened or closed state of the laptop computer; and shutting off the power supplied to the remote-control-signal reception unit of the laptop computer when the laptop computer is closed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 illustrates a structure of a laptop computer controlled by a remote control device, according to a conventional art;

FIG. 2 illustrates a laptop computer in which standby current is controlled with respect to the opened or closed state of the laptop computer, according to an aspect of the present invention;

FIG. 3 illustrates a laptop computer including a remote-control activation unit, according to an aspect of the present invention;

FIG. 4 is a flow chart illustrating a process in which power supplied to a remote-control-signal reception unit is shut-off with respect to the opened or closed state of a laptop computer, according to an aspect of the present invention; and

FIG. 5 illustrates the structure of a laptop computer according to an aspect of the present invention.

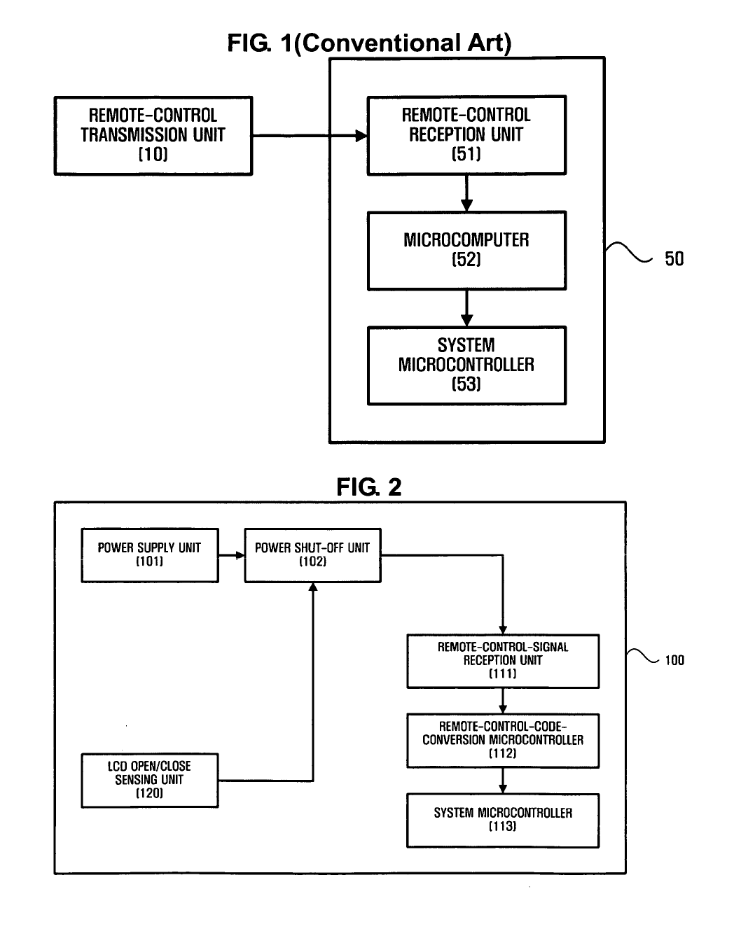

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

Aspects of the present invention are described by referring to drawings showing block diagrams or flow charts that explain a device and a method that controls power supplied to a remote-control-signal reception unit according to an opened or closed state of a laptop computer. Each block of the flow charts and a combination of flow charts can be executed by computer program instructions. The computer program instructions can be executed in the processor of a general-purpose computer, special-purpose computer or other programmable data processing equipment, and the instructions executed via the computers or other programmable data processing equipment generate means for executing the functions described in the flow blocks. It is possible for the computer program instructions to be saved in computer-usable or computer-readable memories in order to implement functions in certain ways, and the instructions saved in the computer-usable or computer-readable memories can produce items containing the instruction means for performing the functions explained in the flow chart blocks.

Also, each block can represent a part of a module, or a segment of code that includes one or more executable instructions for executing specific logical functions. Also, it should be noted that functions mentioned in the blocks can be executed out of order. For example, the illustrated two blocks one after another can be practically executed at the same time, and the blocks sometimes can be executed in reverse order according to the concerned functions.

The terms “unit,” “module,” or “table” used in the aspects of the present invention, refer to a hardware element, a field programmable gate array (FPGA) and/or an application-specific integrated circuit (ASIC). Also, the “module” may execute certain functions. But “module” is not limited to software or hardware. The “module” can reside in an addressable storage media or can reproduce one or more processors. For example, a “module” can include software objects, object-oriented software objects, class objects, task objects, processes, functions, attributes, procedures, circuits, data, database, data structures, tables, arrays, and variables. Modules and functions can be combined to form fewer modules and functions, or they can be further divided into additional modules and functions. Furthermore, modules and functions can be implemented to reproduce one or more CPUs in a device or a security multimedia card.

FIG. 2 illustrates a laptop computer in which standby current is controlled with respect to the opened or closed state of a laptop computer, according to an aspect of the present invention. In various aspects, a laptop computer 100 includes a power supply unit 101, a power shut-off unit 102, a remote-control-signal reception unit 111, a remote-control-code-conversion microcontroller 112, a system microcontroller 113, and an LCD open/close sensing unit 120.

Aspects of the present invention are not limited to laptop computers. It is understood that a laptop is an example of a portable electronic device. In various aspects of the present invention, any electronic device which may be folded, closed, or otherwise made more compact is within the scope of the invention. Examples of such a device include PDAs, cell phones, game consoles, portable computers, or the like. Portable computers and non-portable computers are also within the scope of the invention. Further, it is understood that the electronic device may use a variety of different display types, including non-LCD displays. Examples of non-LCD displays include organic light emitting diode (OLED) displays. Further, it is understood that a sensor to detect the open and/or close state of a cover of the device, such as the LCD open/close sensing unit 120, may be located in, on, and/or around the device, such as the laptop computer.

A remote control device (not shown) transmits a control signal received by the remote-control-signal reception unit 111. Here, a signal having a wavelength in the infrared (IR) region of the electromagnetic (EM) spectrum is preferably used, but a signal having other wavelengths can also be considered. Also usable are non-EM signals, an example of which is sound. The remote-control-signal reception unit 111 receives and transmits signals according to a predetermined manner with the remote control device.

The remote-control-signal reception unit 111 transmits the received signal to the remote-control-code-conversion microcontroller 112 to be converted into a code that activates or deactivates certain functions in the laptop computer 100. The converted code is transmitted to the system microcontroller 113, and activates or deactivates certain functions, devices, and/or elements not shown. For example, the code may stop playback of multimedia contents, increase or decrease volume, or turn on or off the laptop computer 100.

In order for such functions to be performed, the power supply unit 101 continuously supplies power to the remote-control-signal reception unit 111 to receive the signal transmitted by the remote control device at any given time.

Meanwhile, the LCD open/close sensing unit (i.e., an LCD open and/or close sensing unit) 120 detects the opened or closed state of the laptop computer 100. If the laptop computer 100 is detected to be in the opened state, power is supplied to the remote-control-signal reception unit 111 through the power shut-off unit 102, in order to be controlled by the remote control device. On the other hand, if the laptop computer is detected to be in the closed state, because the laptop computer is not going to be used for a relatively long time, the power shut-off unit 102 shuts off power to the remote-control-signal reception unit 111.

As described above, the power shut-off unit 102 shown in FIG. 2 shuts off power supply to the remote-control-signal reception unit 111 when the laptop computer 100 is in the closed state. That is, during the time when the laptop computer 100 is in the closed state, the remote-control-signal reception unit 111 does not have to be in an operating mode and need not receive the signal transmitted by the remote control device. Thus, when the laptop computer 100 is in the closed state, the power shut-off unit 102 shuts off the power supply to the remote-control-signal reception unit 111 to reduce the power consumption in the laptop computer 100.

The LCD open/close sensing unit of FIG. 2 may be connected to a part that connects an LCD unit (not shown) and a main body (not shown) of the laptop computer 100 when the LCD unit is lowered to close the laptop computer. One example of such a part may be one or more hinges. When the LCD portion is fully lowered (hereinafter, referred to as “closed state”), the LCD open/close sensing unit 120 can detect the closed state of the laptop computer 100 by pressure or by an electronic signal generated at the contact point. In various aspects, LCD open/close sensing unit 120 is a sensor, a switch, or the like.

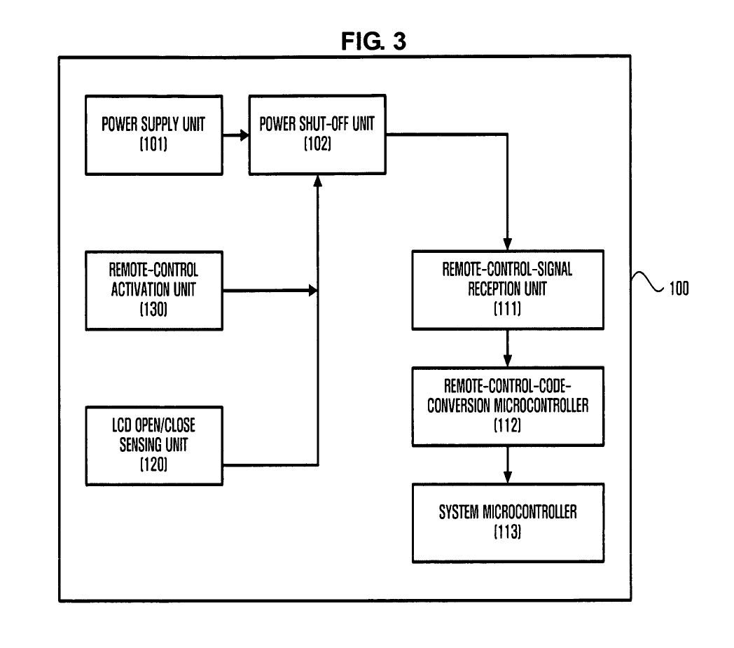

FIG. 3 illustrates laptop computer including a remote-control activation unit 130 according to an aspect of the present invention. A remote-control activation unit 130 enables the laptop computer 100 to receive a remote-control signal when the LCD unit is in the closed state. As described above, if the LCD unit is in the closed state while the laptop computer 100 is turned on or if the laptop computer 100 is set to receive the remote control signal or signals when a user closes the laptop computer 100, power is supplied to the power shut-off unit 102 so that power can be supplied to the remote-control-signal reception unit 111. The remote-control activation unit 130 overrides the power shut-off by the LCD open/close sensing unit 120 so that the remote control signals can be continuously received. Therefore, the remote-control activation unit 130 is mounted at the outside of the laptop computer 100 so that the user can control the laptop computer 100 and/or remote-control activation unit 130 easily.

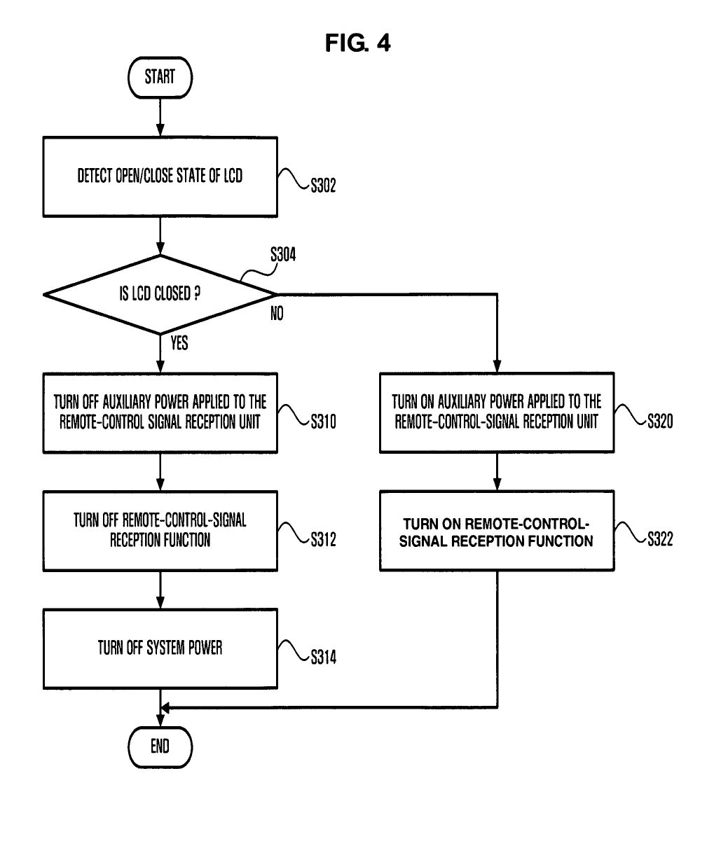

FIG. 4 is a flow chart illustrating a process in which power supplied to the remote-control-signal reception unit is shut-off by the opened or closed state of the laptop computer, according to an aspect of the present invention. The process may be used with the laptop computer 100 shown in FIGS. 2 and 3, but such use of the laptop computer 100 is not required.

First, the LCD open/close sensing unit 120 detects the opened or closed state of the LCD unit in operation S302. If the LCD unit is detected to be in the closed state in operation S304, auxiliary power applied to the remote-control-signal reception unit 111 is turned off in operation S310. As a result, unnecessary power consumption is reduced by turning off the remote-control-signal reception unit 111 in operation S312 and its remote-control-signal reception function. Accordingly, the power supplied to the system in the form of the laptop computer is also turned off in operation S314.

Meanwhile, if the LCD unit is detected to be in the opened state, the auxiliary power applied to the remote-control-signal reception unit 111 is turned on in operation S320. That is, power is supplied to the remote-control-signal reception unit 111, and the remote control reception function is turned on in operation S322.

In contrast to the process illustrated in FIG. 4, if the LCD unit is closed when the system is on, power can be selectively continued to be supplied to the remote-control-signal reception unit 111 because the remote-control activation unit 130 may override or output a signal to override the power shut off by the power shut-off unit 102. This is due to the fact that the system may be operating even when the LCD unit is closed if the system is on.

Also, as illustrated in FIG. 3, when the remote-control activation unit 130 is provided, power can be applied to it so that the remote control signal can be continuously received as a user operates the remote-control activation unit 111 even when the LCD unit is in the closed state. In various aspects of the present invention, power consumption by the remote-control activation unit 130 may be less than that of the remote-control-signal reception unit 111, but such is not required. If less, then the remote-control activation unit 130 receives less than 3.3 v of voltage and/or 3 mA of current.

Through the process illustrated in FIG. 4, when the LCD unit is in the closed state, the power supplied to receive the remote control signals can be reduced, and when the laptop computer is used on a business trip or is in a sleep-mode for an extended period of time, the power consumption can be reduced. Further, by substantially increasing the battery time, the duration of time that the laptop computer can be used in a mobile mode can be extended.

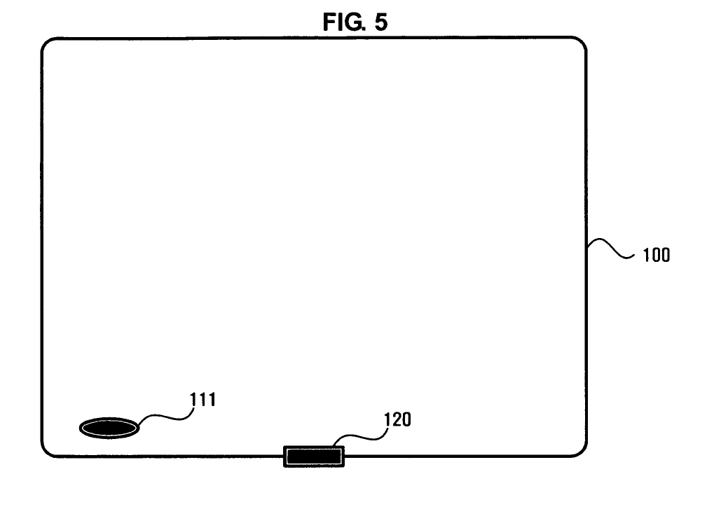

FIG. 5 illustrates the external structure of a laptop computer according to an aspect of the present invention.

In FIG. 5, a laptop computer 100 includes a LCD open/close sensing unit 120 which detects the opened or closed state of the laptop computer 100 or an LCD unit, and a remote-control-signal reception unit 111. The LCD open/close sensing unit 120 transmits a signal corresponding to the opened or closed state of the laptop computer 100 to a power shut-off unit 102 when the LCD unit is opened or closed. The description in which the power shut-off unit shuts off power supply to the remote-control-signal reception unit 111 has already been described above in reference to FIGS. 2, 3 and 4. Thus, the same elaboration here will be omitted.

Although a few aspects of the present invention have been shown and described, it would be appreciated by those skilled in the art that changes may be made in the aspects of the present invention without departing from the principles and spirit of the invention, the scope of which is defined in the claims and their equivalents.

1. A computer device comprising:
a display which is attached to the computer device;
an open/close sensing unit to detect an opened or closed state of the display;
a signal reception unit to receive a remote control signal transmitted from a remote control device;
a power supply unit to supply power to the signal reception unit; and
a power shut-off unit to shut off power supplied to the signal reception unit by the power supply unit according to the result of the detection.

2. The computer device of claim 1, wherein the power shut-off unit allows the power to be supplied from the power supply unit to the signal reception unit according to the result of the detection.

3. The computer device of claim 1, further comprising a remote-control activation unit allowing the power supplied from the power supply unit to the remote-control-signal reception unit so that the remote control signal transmitted from the remote control device can be received regardless of the opened or closed state of the display.

4. A method of controlling power supplied to a remote-control-signal reception unit of a computer device according to an opened or closed state of a display of the computer device, the method comprising:
detecting the opened or closed state of the display; and
shutting off the power supplied to a remote-control-signal reception unit of the computer device when the display is closed.

5. The method of claim 4, further comprising supplying power to the remote-control-signal reception unit of the computer device when the display is opened.

6. The method of claim 4, further comprising overriding the shutting off of power by a remote-control activation unit so that the remote control signal transmitted from a remote control device can be received regardless of the opened or closed state of the display.

7. A device, comprising:
a display open and/or close sensor to output an open and/or close signal based on an open or close state of a display;
a power shut-off unit to receive the open and/or close signal and to shut off standby power and/or current; and
a remote-control-signal-receptor to receive the shut off of the standby power and/or current.

8. The device of claim 7, wherein the power shut-off unit shuts off standby power and/or current when the close signal is received.

9. The device of claim 7, further comprising a remote-control activator to output an override signal to the power shut-off unit to override the close signal.

10. The device of claim 7, wherein the standby power is in the form of a current of about 3 mA and/or voltage of about 3.3 v.

11. The device of claim 9, wherein the remote-control activator receives less power than the standby power.

12. The device of claim 7, wherein the device is a computer device.

13. A device having a display that may be opened or closed, and is usable with a remote control, comprising:
a remote-control-signal receptor to receive a remote-control command from the remote-control; and
a power shut-off unit to shut off power to the remote-control-signal receptor when the display is closed to reduce power consumption in the device.

14. The device of claim 13, wherein the power shut-off unit supplies power to the remote-control-signal receptor when the display is opened.

15. The device of claim 13, further comprising a remote-control activator to selectively override the power shut-off unit from shutting off power to the remote-control-signal receptor even when the display is closed.
